(19) United States
(12) Patent Application Publication
(10) Pub. No.: US 2006/0170881 A1
(43) Pub. Date: Aug. 3, 2006

(54) Rear projector

(75) Inventor: Shigeyuki Seki, Suwa-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/335,542

(22) Filed: Jan. 20, 2006

(30) Foreign Application Priority Data
Jan. 28, 2005 (JP) 2005-021781

(51) Int. Cl. G03B 21/20

(52) U.S. Cl. 353/85; 353/61

(57) ABSTRACT

A rear projector includes: a light source device; an optical system having a light modulation device for modulating light emitted from the light source device in accordance with image information to produce an image, and a projection optical device for enlarging and projecting the image produced by the light modulation device; a screen on which a projection image coming from the projection optical device is projected; a power source system for supplying driving power to the entire rear projector; and a box-shaped housing for accommodating the light source device, the optical system, the power source system and the screen. The housing has a pair of sides which are opposed to each other and extend from the ends of a housing surface on which the screen is formed toward the rear surface of the housing. The light source device is disposed on the side opposite to the power source system side with the optical system interposed therebetween, and the light source device, the optical system and the power source system are arranged along the projection surface of the screen. A first air outlet through which air having cooled the light source device is discharged is formed on the side of the housing close to the light source device, and a second air outlet through which air having cooled the power source system is discharged is formed on the side of the housing close to the power source system.

This application claims the benefit of Japanese Patent Application No. 2005-021781 filed on Jan. 28, 2005. The entire disclosure of the prior application is herby incorporated by reference herein its entirety.

### BACKGROUND

1. Technical Field

The present invention relates to a rear projector which includes: a light source device; an optical system having a light modulation device for modulating light emitted from the light source device in accordance with image information to produce an image, and a projection optical device for enlarging and projecting the image produced by the light modulation device; a screen on which a projection image coming from the projection optical device is projected; a power source system for supplying driving power to the entire rear projector; and a box-shaped housing for accommodating the light source device, the optical system, the power source system and the screen.

2. Related Art

In recent years, a projector used for such applications as home theater has been widely spreading. A known projector of this type includes: a light source device; a light modulation device for modulating light emitted from the light source device in accordance with image information to produced an image; a projection optical device for enlarging and projecting the image produced by the light modulation device; a light-transmissive screen on which a projection image coming from the projection optical device is projected; a control system for controlling operation of the entire projector including the light source and the light modulation device; a power source device for supplying driving power to the entire projector, and a housing for accommodating the entire projector. According to the rear projector having this structure, an image produced by the light modulation device is projected from the rear onto the screen, whereby the image can be visually recognized by an audience from the front.

During operation of the rear projector, the light source device and the power source system are brought into high-temperature conditions. However, a number of components included in the light source device and the power source system are not heat resistant. It is thus necessary to efficiently cool these components so that the rear projector can operate in a stable condition. Accordingly, a rear projector capable of taking in cooling air from the outside and supplying the air to the respective components to cool these has been disclosed (for example, see JP-A-2003-337377).

The rear projector shown in JP-A-2003-337377 includes a cooling airflow path which introduces cooling air from the outside of a housing through an air intake opening provided on one side of the housing (lower cabinet), supplies the cooling air to an optical unit for producing an image and a power source device (first power source device and second power source device), and then discharges the air to the outside through an air outlet provided on the other side of the housing. More specifically, the cooling airflow path is divided into a light source cooling airflow path, an optical device cooling airflow path, a control board cooling airflow path, and a power source cooling airflow path. A part of cooling air introduced through the air intake opening using a fan provided within the housing flows along the control board cooling airflow path and cools the control board (control system). The remaining part of the cooling air flows along the optical device cooling airflow path and cools the optical device. Thereafter, the divided parts of the cooling air are unified above the optical device. A part of the unified cooling air flows along the light source cooling airflow path to cool the light source device, and is discharged through the air outlet opening. The remaining part of the unified cooling air flows along the power source cooling airflow path to cool the power source, and is discharged through the air outlet opening. The air having cooled the light source device is discharged through a duct. In this structure, the respective components of the rear projector can be efficiently cooled.

However, according to the related art disclosed in JP-A-2003-337377, the light source device and the power source device accommodated within the housing are disposed close to each other. As a result, even if the respective airflow paths for cooling these devices are separated by a duct or the like, heat generated in either of the devices may be conducted to the other through a component (such as the duct). In this case, the conducted heat raises the temperature of the cooling air, which makes it difficult to cool the light source device and the power source device appropriately. Particularly, the emission luminance of the light source device used in the recent rear projector has been greatly increased, and the temperature of the light source device during operation tends to be increased accordingly. Therefore, there is a continuing demand for a rear projector capable of effectively cooling the light source device and the power source device.

### SUMMARY

An advantage of some aspects of the invention is to provide a rear projector capable of appropriately cooling a light source device and a power source system so as to enhance the efficiency of cooling these devices.

In order to offer the above advantage, a rear projector according to an aspect of the invention includes: a light source device; an optical system having a light modulation device for modulating light emitted from the light source device in accordance with image information to produce an image, and a projection optical device for enlarging and projecting the image produced by the light modulation device; a screen on which a projection image coming from the projection optical device is projected; a power source system for supplying driving power to the entire rear projector; and a box-shaped housing for accommodating the light source device, the optical system, the power source system and the screen. The housing has a pair of sides which are opposed to each other and extend from the ends of a housing surface on which the screen is formed toward the rear surface of the housing. The light source device is disposed on the side opposite to the power source system side with the optical system interposed therebetween, and the light source device, the optical system and the power source system are arranged along the projection surface of the screen. A first air outlet through which air having cooled the light source device is discharged is formed on the side of the housing close to the light source device, and a second air outlet through which air having cooled the power source system is discharged is formed on the side of the housing close to the power source system.

According to the aspect of the invention, the light source device and the power source system included in the rear projector are opposed to each other with the optical system interposed therebetween, and are arranged along the screen. Thus, the light source device and the power source system are disposed away from each other within the rear projector. Air having cooled the light source device is discharged through the first air outlet formed on the side which is one of the pair of the opposed sides of the housing and is close to the light source device. Air having cooled the power source system is discharged through the second air outlet formed on the other side of the housing. As a result, the airflow path for cooling the light source device and the airflow path for cooling the power source device are separately provided in the rear projector. Since the light source device and the power source system are disposed away from each other with the optical system interposed therebetween and the respective airflow paths for cooling the light source device and the power source system are separated, heat interference between the respective cooling airflow paths for the light source device and for the power source system is avoided. It is therefore possible to prevent unnecessary temperature increase of the cooling air and thus effectively cool the light source device and the power source system.

It is preferable that a duct connecting the first air outlet and the light source device is provided to guide the air having cooled the light source device through the first air outlet to the outside.

In this case, air having cooled the light source device flows within the duct connecting the light source device and the first air outlet to be discharged through the first air outlet. Since the air heated after cooling the light source device is efficiently discharged, diffusion and stay of the heated air within the housing, and thus temperature increase in the inside of the housing can be prevented. It is therefore possible to decrease the inside temperature of the housing and further prevent temperature increase of the components such as the light source device and the power source system included in the rear projector.

It is preferable that a cooling fan for cooling the light source device is provided between the first air outlet and the light source device, and that the air intake plane of the cooling fan is opposed to the light source device.

In this case, the cooling fan may be a centrifugal force fan (sirocco fan) which discharges air attracted from the direction of the fan rotation axis toward the direction tangential to the fan rotation, or may be an axial fan which rotates a fan around the rotation axis to take in and discharge air along the direction of the rotation axis.

The cooling fan is disposed in such a position that the air intake plane of the cooling fan is opposed to the light source device. Since the light source device is positioned on the air intake side of the cooling fan, the air around the light source device flows along the light source device while cooling the light source device at the time of actuation of the cooling fan, and is attracted toward the air intake plane of the cooling fan. As a result, the air can be supplied to the light source device without diffusion, and the air having cooled the light source device can be discharged to the outside of the housing. Accordingly, the efficiency of cooling the light source device can be further enhanced.

Since the air intake plane of the cooling fan is opposed to the light source device, the air around the light source device is prevented from staying thereabout by the operation of the cooling fan. Accordingly, the efficiency of cooling the light source device can be further increased.

In the arrangement where the cooling fan is disposed above the light source device, the air heated after cooling the light source device can be efficiently attracted and discharged. Thus, the efficiency of cooling the light source device can be further improved.

It is preferable that the housing has legs, and that a bottom on which at least the light source device and the power source system are mounted is equipped within the housing. The bottom is disposed a predetermined distance away from an installation surface on which the housing is installed. At least two air inlets through which air is introduced into a space below the bottom when the housing is installed are formed at least on any surface of the housing. A light source device cooling opening through which air entering from one of the two air inlets is introduced to the light source device is formed in the vicinity of the light source device, and a power source system cooling opening through which air entering from the other air inlet is introduced to the power source system is formed in the vicinity of the power source system.

In this case, the airflow path (cooling airflow path) for cooling the light source device and the airflow path for cooling the power source system can be separated.

More specifically, air introduced through one of the air inlets to the space below the bottom flows from the light source device cooling opening toward the light source device, cools the light source device, and then is discharged through the first air outlet formed on the side of the housing close to the light source device. Air introduced through the other air inlet to the space below the bottom flows from the power source system cooling opening toward the power source system, cools the power source system, and then is discharged through the second air outlet formed on the side of the housing close to the power source system. In this structure, the cooling airflow path for the light source device and the cooling airflow path for the power source system are more securely separated, and thus heat interference therebetween is further prevented. Accordingly, the efficiency of cooling the light source device and the power source system can be enhanced.

Since the cooling airflow path for the light source device and the cooling airflow path for the power source system are separated, appropriate flows of air are formed and thus the inside temperature of the housing is further decreased. Accordingly, the components included in the rear projector can be further effectively cooled.

It is preferable that a partition wall for separating air introduced through the air inlets is equipped on the lower surface of the bottom.

In this case, the cooling airflow path for the light source device and the cooling airflow path for the power source system can be more securely separated by separating the respective airflow paths extending from the air inlets to the light source device and the power source system, respectively, using the partition wall. As a result, heat interference between the respective airflow paths reaching the light source device and the power source system, respectively, can be further prevented.

Moreover, since the respective airflow paths are separately provided, concentration of airflow on either the light source device or the power source system can be avoided. It is thus possible to equally cool the light source device and the power source system.

### BRIEF DESCRIPTION OF THE DRAWINGS

The invention will be described with reference to the accompanying drawings, wherein like numbers refer to like elements.

FIG. 1 is a perspective view of a rear projector in an embodiment according to the invention as viewed from the front.

FIG. 2 is a perspective view of the rear projector in the embodiment as viewed from the rear.

FIG. 3 is a side view of the rear projector in the embodiment as viewed from the left.

FIG. 4 is a perspective view illustrating an inside structure of an upper cabinet in the embodiment.

FIG. 5 is a perspective view illustrating an inside structure of a lower cabinet in the embodiment.

FIG. 6 schematically illustrates the inside structure of the lower cabinet in the embodiment.

FIG. 7 is a perspective view of an optical unit in the embodiment.

FIG. 8 schematically illustrates an optical system of the optical unit in the embodiment.

FIG. 9 illustrates a bottom of the lower cabinet in the embodiment as viewed from below.

FIG. 10 schematically shows positions of openings in the embodiment.

FIG. 11 illustrates cooling airflow paths in the embodiment.

### DESCRIPTION OF EXEMPLARY EMBODIMENT

A rear projector in an embodiment according to the invention is hereinafter described with reference to the appended drawings.

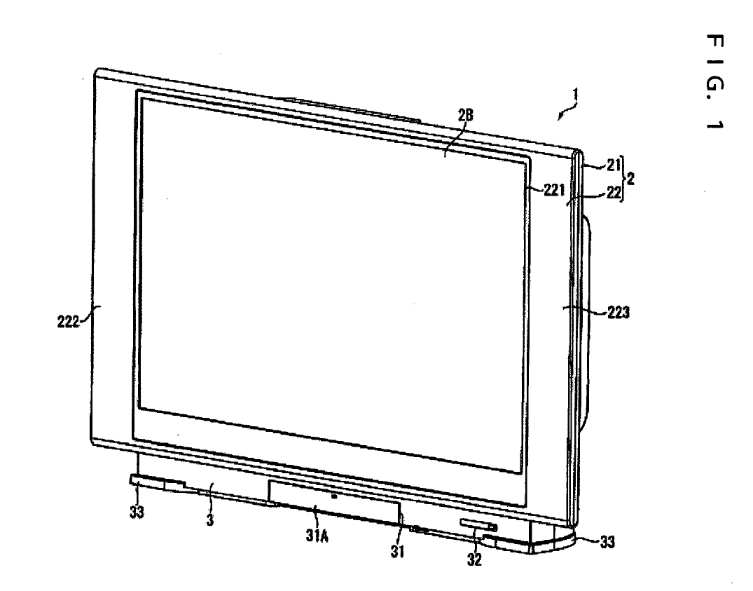

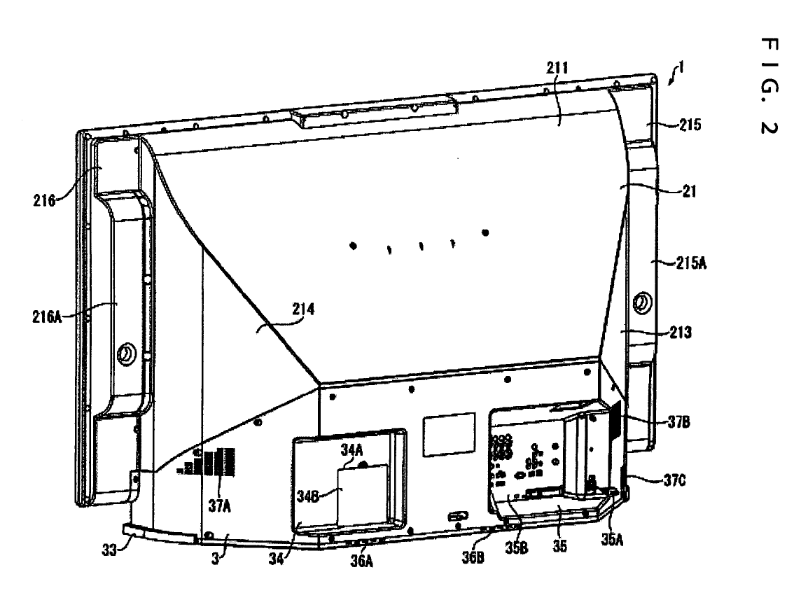

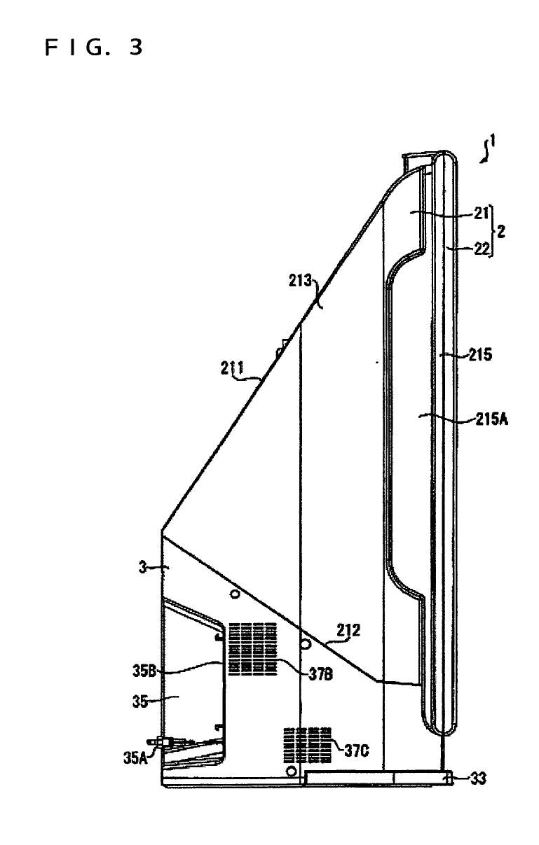

FIG. 1 is a perspective view of a rear projector 1 in this embodiment as viewed from the front. FIG. 2 illustrates the rear projector 1 as viewed from the rear. FIG. 3 illustrates the rear projector 1 as viewed from the left. The left in FIG. 3 corresponds to the left side of the rear projector 1 as viewed from the front.

The rear projector 1 modulates light emitted from a light source in accordance with inputted image information to produce an optical image, and enlarges and projects the produced optical image onto a light-transmissive screen 2B included in the rear projector 1.

1. Structure of Outward Appearance

As illustrated in FIGS. 1 through 3, the rear projector 1 has a substantially rectangular shape as viewed from the front, and includes an upper cabinet 2 having a substantially triangle vertical cross section, and a lower cabinet 3 for supporting the upper cabinet 2 from below. The upper cabinet 2 and the lower cabinet 3 are fixed to each other by screws or the like.

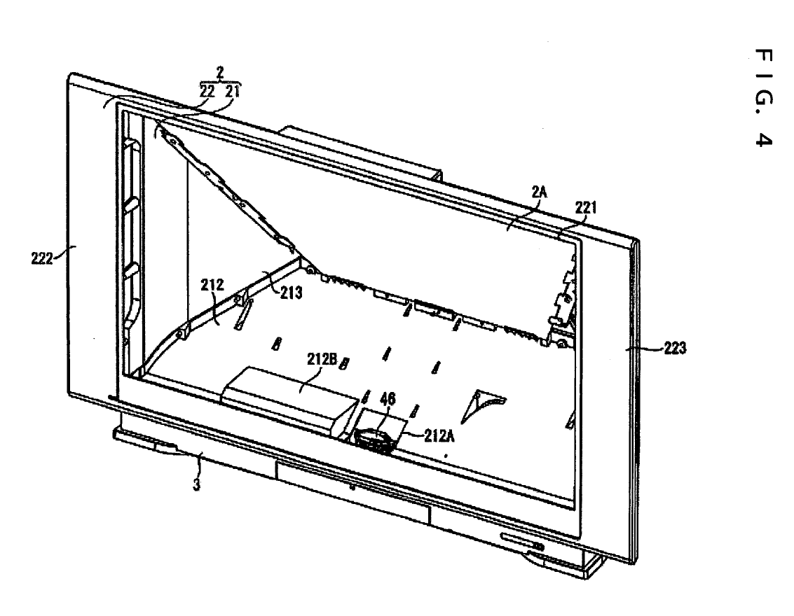

As illustrated in FIG. 1, the upper cabinet 2 has a mirror case 21 containing a reflection mirror 2A (FIG. 4) to be described later, and a frame 22 for holding a screen 2B.

The lower cabinet 3 for supporting the upper cabinet 2 is a box-shaped housing which has a substantially trapezoidal shape in the plan view and accommodates the main components of the rear projector 1.

1-1. Front Structure of Rear Projector 1
As illustrated in FIG. 1, the frame 22 is disposed on the front side of the rear projector 1, i.e., the front side of the upper cabinet 2.

The frame 22 has approximately the same dimensions as those of the front side of the mirror case 21 (FIG. 2) to be described later, and has a substantially rectangular shape in the front view. The frame 22 is fixed to the front side of the mirror case 21 by screws or the like.

The frame 22 holds the screen 2B on which an optical image is projected as described above. Thus, a substantially rectangular opening 221 having approximately the same size as that of an optical image projection region of the screen 2B is formed approximately at the center of the frame 22, and the screen 2B is exposed through the opening 221. A pair of speaker sections 222 and 223 on each rear part of which two speakers (not shown) are provided are formed on the left and right sides of the opening 221.

The screen 2B has protection plates such as a Fresnel sheet, a lenticular sheet, and a glass plate. The Fresnel sheet collimates light emitted from a projection lens of an optical unit to be described later and reflected by the reflection mirror 2A (FIG. 4) to be described later. The lenticular sheet diffuses the light transmitted and collimated by the Fresnel sheet such that the display image can be visually recognized in an appropriate manner.

A substantially rectangular opening 31 is provided approximately at the center of the front side of the lower cabinet 3. A lid 31A rotates upward and downward to close and open the opening 31.

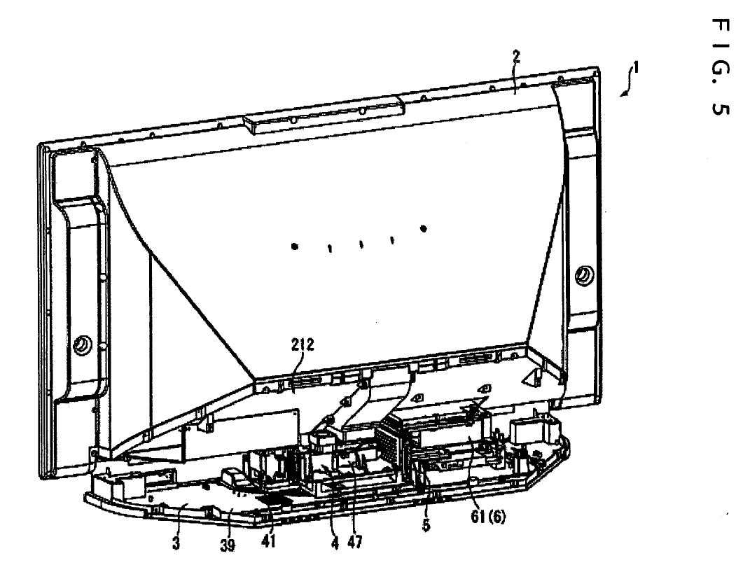

A front panel as a front-side operation panel which is not shown in detail in the figures is provided within the opening 31. Various operation switches for controlling volume, image quality and others, a D-sub terminal as a PC (personal computer) connection terminal, a stereo sound input terminal, a video input terminal, an S-terminal and the like are equipped in the left region of the front panel. An opening through which various semiconductor memory cards can be inserted is provided in the right region of the front panel, and a card reader capable of reading data from the cards is equipped within the opening. A power source switch 32 is disposed on the right side of the opening 31. The front panel and the power source switch 32 are electrically connected with a control board 5 (FIG. 5) to be described later.

Additionally, legs 33 are formed at the left and right ends of the front side of the lower cabinet 3.

1-2. Rear Structure of Rear Projector 1
As illustrated in FIGS. 2 and 3, the rear side of the rear projector 1 includes the mirror case 21 of the upper cabinet 2 and the lower cabinet 3.

The mirror case 21 is a box-shaped housing which is made of synthetic resin and has a substantially triangle vertical cross section. The mirror case 21 has a rear wall 211 constituting the rear surface of the rear projector 1, a bottom wall 212 connected to the lower end of the rear wall 211, a pair of side walls 213 and 214 disposed on the left and right sides of the rear wall 211 and the bottom wall 212. Extensions 215 and 216 are provided on the front side of the mirror case 21. The extensions 215 and 216 cross the side walls 213 and 214 approximately at right angles, respectively, and extend away from each other, i.e., in the right-to-left direction of the rear projector 1.

The rear wall 211 has a substantially trapezoidal shape having a longer upper side in the plan view, and is inclined downward toward the rear. The reflection mirror 2A (FIG. 4) to be described later is supported by the inner surface of the rear wall 211 at a predetermined angle.

The pair of the side walls 213 and 214 are connected to the left and right ends of the rear wall 211 and the bottom wall 212, and are inclined to the inside as they extend toward the rear.

The extensions 215 and 216 extend longer than the longitudinal dimensions of the side walls 213 and 214. Projections 215A and 216A projecting toward the rear are provided approximately at the center of the extensions 215 and 216, respectively. The projections 215A and 216A form speaker enclosures together with the speaker sections 222 and 223 (FIG. 1) of the frame 22.

As described above, the lower cabinet 3 is a box-shaped housing, which has a substantially trapezoidal shape in the plan view in correspondence with the shape of the upper cabinet 2 in the plan view, and is surrounded by side walls in all directions.

A first concave 34 and a second concave 35 are provided on the rear surface of the lower cabinet 3 in the left region and right region of FIG. 2, respectively.

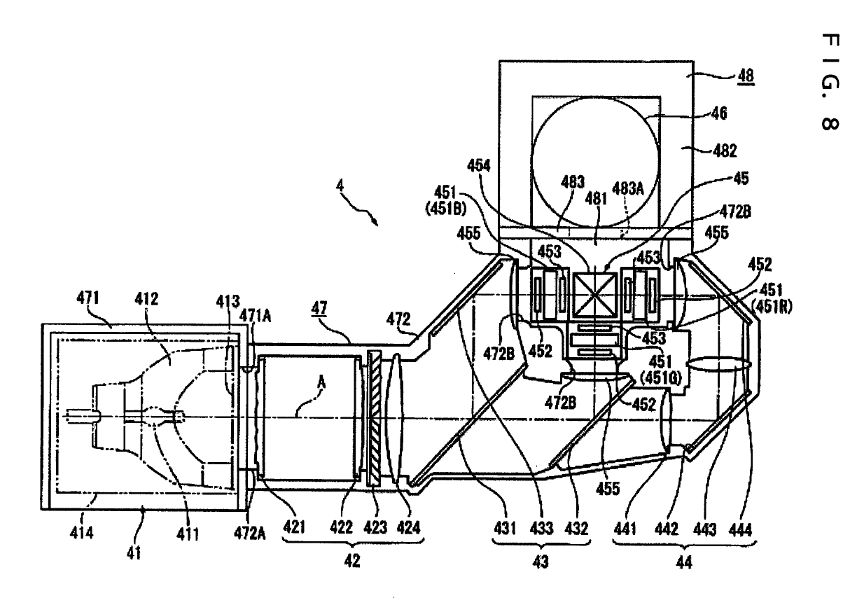

A lamp replacement opening 34A having a substantially square shape is formed on the first concave 34, and is covered by a lamp cover 34B. The lamp replacement opening 34A is opened by removing the lamp cover 34B. A light source device 41 (FIGS. 5 and 8) of an optical unit 4 to be described later can be replaced through the lamp replacement opening 34A.

A power source cable 35A and a rear panel 35B as a rear-side operation panel are disposed on the second concave 35. More specifically, a DVI (digital visual interface) terminal as a PC connection terminal, an antenna input terminal, video/sound input/output terminals of plural systems and the like are equipped on the rear panel 35B.

A pair of air inlets 36 (36A, 36B) for introducing cooling air for cooling the electronic components accommodated within the lower cabinet 3 are formed below the first concave 34 and the second concave 35, respectively.

Air outlets 37 (37A, 37B, 37C) are formed on both sides of the lower cabinet 3 with its rear surface interposed between the both sides, more specifically, on the left side of the first concave 34 and the right side of the second concave 35, respectively, as viewed from the rear of the lower cabinet 3. These air outlets 37A through 37C are openings through which air having cooled the respective devices within the lower cabinet 3 is discharged, and are slit-shaped.

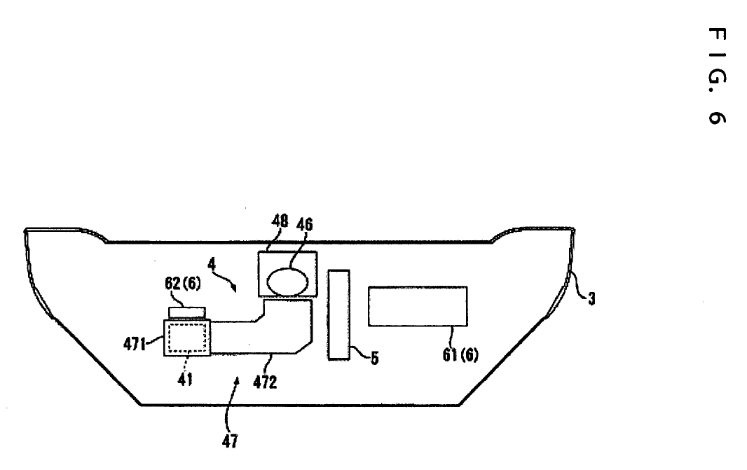

The air outlet 37A formed on the left side of the fist concave 34 corresponds to a first air outlet of the invention, through which air having cooled the light source device 41 (FIG. 5) and a light source driving block 62 (FIG. 6) to be described later is discharged. The air outlets 37B and 37C formed on the right side of the second concave 35 correspond to a second air outlet of the invention, through which air having cooled a control board 5 (FIG. 5) and a power source block 61 (FIG. 6) is discharged.

2. Inside Structure
2-1. Inside Structure of Upper Cabinet 2
   FIG. 4 illustrates the inside structure of the upper cabinet 2. More specifically, FIG. 4 is a front-side perspective view of the rear projector 1 shown in FIG. 1 from which the screen 2B is removed.

As illustrated in FIG. 4, the reflection mirror 2A for reflecting light as an optical image emitted from a projection lens 46 (FIG. 8) of the optical unit 4 (FIGS. 5 and 8) to be described later provided within the lower cabinet 3 is accommodated within the upper cabinet 2. The reflection mirror 2A is a mirror of a typical type which is substantially trapezoidal in the plan view and has approximately the same shape as that of the rear wall 211 (FIG. 2). The reflection mirror 2A is attached to the inside of the rear wall 211 (FIG. 2) of the upper cabinet 2 with inclination such that the trapezoidal shape of the reflection mirror 2A has a longer upper side. The inclination angle of the reflection mirror 2A is determined based on the established positional relationship between the screen 2B (FIG. 1) attached to the front side and the image reflection by the projection lens 46 (FIG. 8) of the optical unit 4 (FIGS. 5 and 8) to be described later.

The bottom wall 212 of the mirror case 21 has a substantially trapezoidal shape in the plan view having a longer side positioned at the front. As illustrated in FIGS. 2 and 3, the bottom wall 212 is inclined upward as it extends toward the rear. The rear end of the bottom wall 212 is connected to the rear wall 211, and the left and right ends of the bottom wall 212 are connected to the side walls 213 and 214, respectively.

As illustrated in FIG. 4, a substantially rectangular notch 212A is formed approximately at the center of the front side of the bottom wall 212, and the projection lens 46 of the optical unit 4 (FIGS. 5 and 8) to be described later is exposed through the notch 212A. A projection 212B projecting upward is formed on the left side of the notch 212A. The projecting 212B is located at a position corresponding to the position of the power source block 61 (FIG. 5) of the power source unit 6 (FIG. 5) to be described later.

2-2. Inside Structure of Lower Cabinet 3
FIG. 5 illustrates the inside structure of the lower cabinet 3. More specifically, FIG. 5 is a rear-side perspective view of the rear projector 1 shown in FIG. 2 from which an outside case on the rear surface of the lower cabinet 3 is removed. FIG. 6 is a plan view schematically illustrating the inside structure of the lower cabinet 3.

The optical unit 4 for producing an image, the control board 5 for controlling the entire operation of the rear projector 1, the power source unit 6 for supplying driving power to the respective electronic components constituting the rear projector 1, and other parts are accommodated within the lower cabinet 3. More specifically, the optical unit 4, the control board 5 and the power source unit 6 are equipped on a bottom 39 of the lower cabinet 3 along the screen 2B held by the upper cabinet 2. Thus, the chief processes such as image production performed in the rear projector 1 are carried out by the components accommodated within the lower cabinet 3.

As illustrated in FIGS. 5 and 6, the optical unit 4 is disposed between approximately the center and the right end of the lower cabinet 3, i.e., on the left side as viewed from the rear. The control board 5 and the power source unit 6 are disposed between approximately the center and the left end of the lower cabinet 3, i.e., on the right side as viewed from the rear.

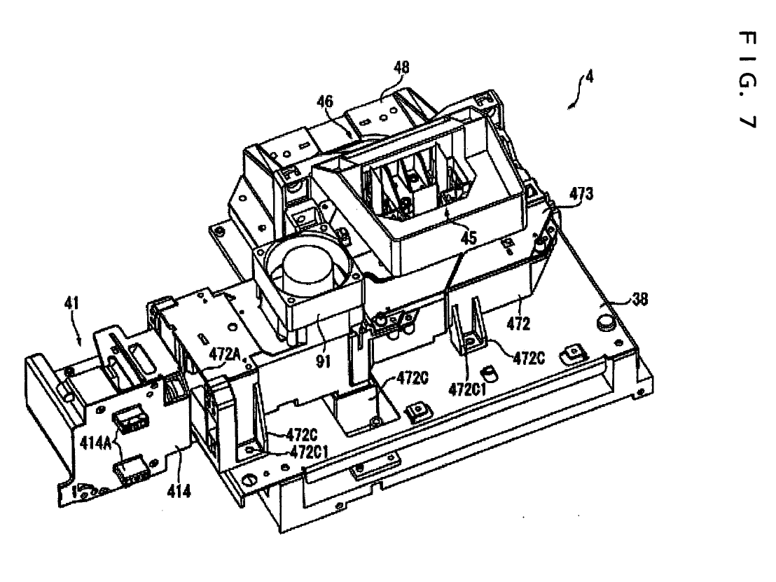

3. Structure of Optical Unit 4
FIG. 7 is a perspective view of the optical unit 4. FIG. 8 schematically illustrates the optical system of the optical unit 4.

The optical unit 4 produces an optical image by modulating light emitted from the light source device 41 in accordance with inputted image information using liquid crystal panels 451, and enlarges and projects the produced optical image on the screen 2B (FIG. 1) through the reflection mirror 2A (FIG. 4) using the projection lens 46. As illustrated in FIG. 7, the optical unit 4 is mounted on an optical unit stand 38 provided on the upper surface of the bottom 39 (FIG. 5) of the lower cabinet 3.

The optical unit stand 38 is formed by a plurality of plates and fixes the optical unit 4 at a predetermined position.

As illustrated in FIG. 8, the optical unit 4 includes the light source device 41, an integrator illumination optical system 42, a color separation optical system 43, a relay optical system 44, an electro-optical device 45, the projection lens 46 as a projection optical device, an optical component housing 47 within which these devices are accommodated, and a head body 48 for holding and fixing the projection lens 46. The integrator illumination optical system 42, the color separation optical system 43, the relay optical system 44, the electro-optical device 45, and the projection lens 46 as the projection optical system correspond to the optical system of the invention.

The light source device 41 is disposed at the rightmost position of the optical unit 4, i.e., at the leftmost position of the optical unit 4 as viewed from the rear of the rear projector 1. Thus, the light source device 41 is located at a position most away from the power source block 61 in the components constituting the optical unit 4.

The light source device 41 includes a light source lamp 411 as a light emission source, a reflector 412, an explosion-proof glass 413, and a light source lamp box 414 as a synthetic resin housing within which these components are accommodated. The light source device 41 reflects light radially emitted from the light source lamp 411 by the reflector 412 to collimate the light, and emits the collimated light through the explosion-proof glass 413 to the outside.

In this embodiment, the light source lamp 411 is formed by a high pressure mercury lamp. Alternatively, a metal halide lamp, a halogen lamp or others may be employed instead of the high pressure mercury lamp. The reflector 412 is formed by a parabolic mirror, but a combination of a collimating concave lens and an ellipsoidal mirror may be employed in lieu of the parabolic mirror.

The explosion-proof glass 413 is a light-transmissive glass component for closing the opening of the reflector 412. The explosion-proof glass 413 prevents broken pieces of the light source lamp 411 from scattering to the outside of the light source lamp box 414 in case of explosion of the light source lamp 411.

As illustrated in FIG. 7, a pair of handles 414A which extend toward the rear when the light source device 41 is accommodated within the rear projector 1 are provided on the light source lamp box 414 such that the light source lamp box 414 can be easily held for the replacement of the light source device 41. When the light source device 41 needs to be replaced for such reasons as life end and breakage of the light source lamp 411, the lamp cover 34B (FIG. 2) is opened to replace the entire light source device 41 through the lamp replacement opening 34A (FIG. 2).

The integrator illumination optical system 42 is an optical system for substantially uniformly illuminating the image forming regions of the three liquid crystal panels 451 which will be described later and constitute the electro-optical device 45. As illustrated in FIG. 8, the integrator illumination optical system 42 includes a first lens array 421, a second lens array 422, a polarization conversion element 423, and a superposing lens 424.

The first lens array 421 has a structure in which small lenses each having a substantially rectangular outline as viewed from the direction of the optical axis are arranged in matrix. Each of the small lenses divides light emitted from the light source device 41 into a plurality of partial lights.

The second lens array 422 has a structure similar to that of the first lens array 421, where small lenses are arranged in matrix. The second lens array 422 forms the image produced by the respective small lenses of the first lens array 421 on the liquid crystal panels 451 to be described later together with the superposing lens 424.

The polarization conversion element 423 is interposed between the second lens array 422 and the superposing lens 424. The polarization conversion element 423 converts light coming from the second lens array 422 into approximately one type linear polarized light such that the utilization efficiency of light can be enhanced at the electro-optical device 45.

More specifically, each of the partial lights converted into approximately one type linear polarized light by the polarization conversion element 423 is substantially superposed on the liquid crystal panels 451 to be described later included in the electro-optical device 45 by the superposing lens 424 in the final step. Since the rear projector 1 which includes the liquid crystal panels 451 modulating polarized light uses only one type linear polarized light, about only half of light emitted from the light source lamp 411 which releases random polarized lights of other types can be utilized. Thus, the light emitted from the light source lamp 411 is converted into approximately one type linear polarized light using the polarization conversion element 423 such that the utilization efficiency of light can be enhanced at the electro-optical device 45.

The polarization conversion element 423 of this type has been disclosed in JP-A-8-304739, for example.

The color separation optical system 43 includes a pair of dichroic mirrors 431 and 432, and a reflection mirror 433. The color separation optical system 43 separates light emitted from the integrator illumination optical system 42 into three lights having red (R), green (G) and blue (B) colors by the dichroic mirrors 431 and 432.

The relay optical system 44 includes an entrance-side lens 441, a relay lens 443, and reflection mirrors 442 and 444. The relay optical system 44 introduces the red light having been separated at the color separation optical system 43 to a liquid crystal panel 451R for red light to be described later included in the electro-optical device 45.

In this process, the lights having red and green colors emitted from the integrator illumination optical system 42 pass through the dichroic mirror 431 of the color separation optical system 43, and the light having blue color is reflected by the dichroic mirror 431. The blue light reflected by the dichroic mirror 431 is again reflected by the reflection mirror 433, passes through a field lens 455, and then reaches a liquid crystal panel 451 B for blue light to be described later included in the electro-optical device 45. The field lens 455 converts the respective partial lights emitted from the second lens array 422 into lights parallel to its center axis (principal ray). The field lenses 455 provided on the light entrance sides of other light modulation devices for green and red lights have similar functions.

The green light as one of the red and green lights passing through the dichroic mirror 431 is reflected by the dichroic mirror 432, passes through the field lens 455, and then reaches a liquid crystal panel 451G for green light. On the other hand, the red light passes through the dichroic mirror 432, and further through the relay optical system 44 and the field lens 455, and reaches a liquid crystal panel 451R for red light.

Since the length of the optical path of the red light is larger than those of other lights, the relay optical system 44 is used for the red light so as to prevent lowering of the utilization efficiency of light due to emission of light or other reasons. That is, the relay optical system 44 is used so that the partial light having entered the entrance-side lens 441 can be transmitted to the field lens 455 as it is. While the relay optical system 44 transmits the red light in the lights having three colors in this embodiment, it may transmit other colors such as blue and green lights.

The electro-optical device 45 modulates light having entered thereinto in accordance with image information to produce a color image. The electro-optical device 45 includes three entrance-side polarizing plates 452 into which lights having respective colors separated by the color separation optical system 43 enter, the three liquid crystal panels 451 (liquid crystal panel for red light 451R, liquid crystal panel for green light 451G, and liquid crystal panel for blue light 451B) as light modulation elements each disposed after the corresponding entrance-side polarizing plates 452 in the optical path, three exit-side polarizing plates 453 each disposed after the corresponding liquid crystal panels 451 in the optical path, and a cross dichroic prism 454 as a color synthesizing optical device. The entrance-side polarizing plates 452, the liquid crystal panels 451, the exit-side polarizing plates 453, and the cross dichroic prism 454 are provided as units. The entrance-side polarizing plates 452, the liquid crystal panels 451, and the exit-side polarizing plates 453 are disposed a predetermined distance away from one another, though not particularly shown in the figure.

The lights having respective colors converted into approximately one-directional polarized lights by the polarization conversion element 423 enter the entrance-side polarizing plates 452. The entrance-side polarizing plates 452 transmit only the polarized lights approximately in the same direction as that of the polarization axis of the lights converted by the polarization conversion element 423, and absorb other lights. Each of the entrance-side polarizing plates 452 is formed by affixing a polarization film on a light-transmissive substrate such as a sapphire glass and a crystal.

The liquid crystal panels 451 correspond to the light modulation device of the invention, and have liquid crystals as electro-optical substances sealed between a pair of transparent glass substrates. The liquid crystal panels 451 control the orientations of the liquid crystals within the image forming region in accordance with driving signals outputted from the control board to be described later to modulate the directions of the polarized lights emitted from the entrance-side polarizing plates 452.

The exit-side polarizing plates 453 have approximately the same structure as that of the entrance-side polarizing plates 452. The exit-side polarizing plates 453 transmit only the lights having the polarization axis perpendicular to the light transmission axis of the entrance-side polarizing plates 452 among the lights emitted from the image forming region of the liquid crystal panels 451, and absorb other lights.

The cross dichroic prism 454 is an optical element which produces a color image by synthesizing optical images formed by the lights in respective colors each of which is emitted from the exit-side polarizing plates 453 and modulated. The cross dichroic prism 454 is a square-shaped component in the plan view formed by combining four rectangular prisms, and two dielectric multilayer films are provided on the boundaries between the adjoining rectangular prisms. These dielectric multilayer films reflect the lights in respective colors coming from the liquid crystal panels 451R and 451B and passing through the exit-side polarizing plates 453, and transmit the light coming from the liquid crystal panel 451G and passing through the exit-side polarizing plates 453. Thus, the cross dichroic prism 454 synthesizes the lights in respective colors having been modulated by the liquid crystal panels 451R, 451G and 451B, and produces the color image.

The projection lens 46 has a structure in which a plurality of lenses and a mirror to polarize entering light are housed within a mirror cylinder. The projection lens 46 enlarges the color image emitted from the electro-optical device 45, and projects the color image toward the reflection mirror 2A (FIG. 4) while bending upward the direction of the color image emitted toward the front. As illustrated in FIG. 8, the projection lens 46 is disposed on the light exit side of the electro-optical device 45 and is fixed to the head body 48. As illustrated in FIG. 4, the projection lens 46 is positioned approximately at the center on the front side of the lower cabinet 3, and is exposed to the inside of the mirror case 21 through the notch 212A formed on the bottom wall 212 of the upper cabinet 2.

As illustrated in FIG. 8, a predetermined illumination optical axis A is established within the optical component housing 47, and the above optical components 42 through 45 are disposed at predetermined positions with respect to the illumination optical axis A. As illustrated in FIGS. 7 and 8, the optical component housing 47 includes a light source device accommodating member 471, a component accommodating member 472, and a cover member 473.

The light source device accommodating member 471 is a box-shaped component which is open to the rear and has a substantially U-shaped cross section, though not particularly shown in the figures. For accommodating the light source device 41 within the light source device accommodating member 471, the light source lamp box 414 is slid toward the front into the light source device accommodating member 471. On the other hand, for removing the light source device 41 from the light source device accommodating member 471, the light source lamp box 414 is slid toward the rear.

The light source device accommodating member 471 is connected to the component accommodating member 472. An opening 471A through which the light emitted from the light source lamp 411 of the light source device 41 passes is provided at the joint between the light source device accommodating member 471 and the component accommodating member 472.

The component accommodating member 472 is a box-shaped housing made of synthetic resin, and is open to above to have a substantially U-shaped cross section. As described above, one end of the component accommodating member 472 is connected with the light source device accommodating member 471, and the other end is connected with the head body 48 for holding and fixing the electro-optical device 45 and the projection lens 46. A substantially rectangular opening 472A is provided at the end of the component accommodating member 472 connected with the light source device accommodating member 471 such that the light emitted from the light source device 41 accommodated within the light source accommodating member 471 can pass through the inside of the component accommodating member 472.

A plurality of grooves are formed on the inner surface of the component accommodating member 472. The optical components 421 through 424, 431 through 433, 441 through 444, and 455 are fitted from above into the grooves so as to be positioned thereon and fixed thereto.

As illustrated in FIG. 8, a notch 472B as a light transmission opening is formed at each exit-side end surface of the component accommodating member 472, which end surface is substantially U-shaped in the plan view and releases the light emitted from the light source lamp 411 of the light source device 41 and introduced through the inside. The field lens 455 is attached to the periphery of each notch 472B in such a position as to close the notch 472B.

As illustrated in FIG. 7, a plurality of legs 472C are provided on the outer surface of the component accommodating member 472. The legs 472C are used to fix the component accommodating member 472 to the optical unit stand 38. The component accommodating member 472 is fixed to the optical unit stand 38 using screws which are inserted through holes 472C1 formed on the legs 472C.

As illustrated in FIG. 7, the cover member 473 is a synthetic resin housing which has a shape corresponding to that of the component accommodating member 472 in the plan view and closes the upper opening of the component accommodating member 472.

An opening (not shown) is formed on the cover member 473 at the position corresponding to the polarization conversion element 423. A cooling fan 91 for cooling the polarization conversion element 423 is provided above this opening.

As illustrated in FIG. 8, the head body 48 for holding and fixing the projection lens 46 is provided at the end of the light exit side of the component accommodating member 472.

The head body 48 is made of metal such as aluminum alloy and magnesium alloy. The head body 48 connects the electro-optical device 45 and the projection lens 46, and attaches the connected unit to the optical component housing 47.

The head body 48 is substantially T-shaped in an upside-down position in the side view though not particularly shown in the figures, and includes a light entrance side horizontal portion 481, a light exit side horizontal portion 482, and a vertical portion 483 which is interposed between the horizontal portions 481 and 482 and vertically stands from the horizontal portions 481 and 482.

The electro-optical device 45 is fixed to the light entrance side horizontal portion 481, while the projection lens 46 is fixed to the light exit side horizontal portion 482. An opening 483A through which the light emitted from the electro-optical device 45 is introduced to the projection lens 46 is formed on the vertical portion 483.

4. Structure of Control Board 5
The control board 5 is disposed on the left side of the projection lens 46 when the rear projector 1 is viewed from the front. That is, the control board 5 is vertically mounted on the right side from the center in FIGS. 5 and 6 and on the side opposite to the light source device 41 side with the projection lens 46 interposed between the control board 5 and the light source device 41.

The control board 5 is a circuit board on which a CPU (central processing unit), a ROM (read only memory), and a RAM (random access memory) and others are equipped. The control board 5 processes image information inputted from respective connection terminals provided on the front panel and the rear panel 35B (FIG. 2) and operation signals sent from operation buttons disposed on the front panel to control the entire operation of the rear projector 1 (FIG. 1) including the optical unit 4 (FIGS. 5 and 8) and the liquid crystal panels 451 (FIG. 8). As illustrated in FIG. 5, the entire control board 5 is covered with a metal shield having a plurality of holes so as to protect the control board 5 from EMI (electromagnetic interference).

5. Structure of Power Source Unit 6
The power source unit 6 converts alternating current inputted from the outside into direct current, and supplies driving power to the respective electronic components constituting the rear projector 1 (FIG. 1).

As illustrated in FIGS. 5 and 6, the power source unit 6 includes the power source block 61 connected with the power source cable 35A (FIG. 2) equipped on the rear surface of the lower cabinet 3, and a light source driving block 62 disposed on the front side of the light source device accommodating member 471 to supply driving power to the light source lamp 411 (FIG. 8) included in the light source device 41.

The power source block 61 corresponds to the power source system of the invention. As illustrated in FIGS. 5 and 6, the power source block 61 is disposed on the right part of the lower cabinet 3 as viewed from the rear and on the side opposite to the light source device 41 side with the projection lens 46 interposed between the power source block 61 and the light source device 41. The power source block 61 converts commercial alternating current inputted through the power source cable 35A (FIG. 2) into direct current, increases or decreases its voltage to a value according to the respective electronic components, and then supplies the current to the electronic components included in the light source driving block 62, the control board 5 and others.

The light source driving block 62 is a circuit board which rectifies the direct current supplied from the power source block 61 and varies its voltage to generate rectangular waveform alternating current. The light source driving block 62 then supplies the rectangular waveform alternating current to the light source lamp 411 (FIG. 8) of the light source device 41 to turn on the light source lamp 411 (FIG. 8). The light source driving block 62 is electrically connected with the control board 5 such that turning on of the light source lamp 411 (FIG. 8) can be controlled by the control board 5 through the light source driving block 62.

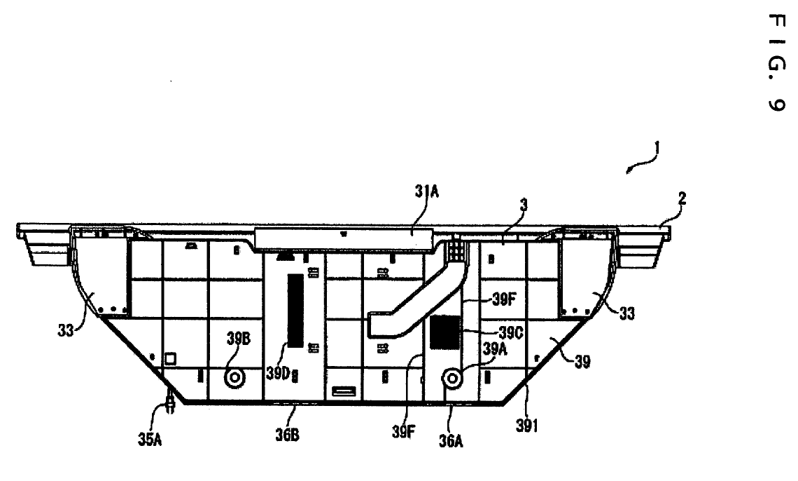

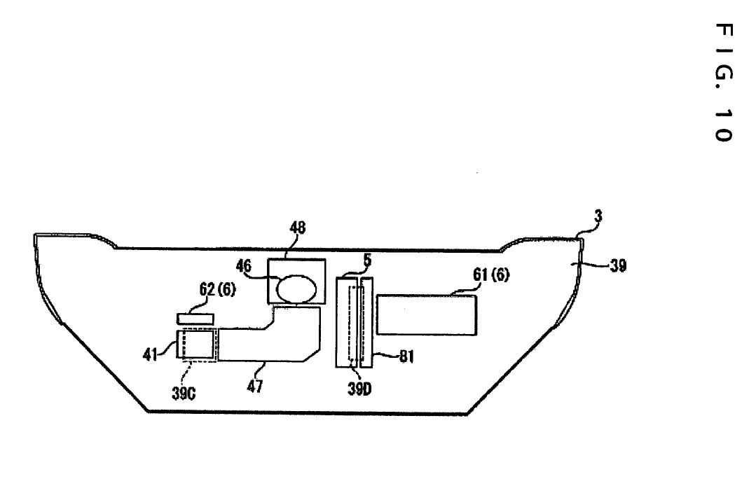

6. Cooling System
6-1. Structure of Cooling System
FIG. 9 illustrates the rear projector 1 as viewed from below. That is, FIG. 9 illustrates the bottom 39 of the lower cabinet 3 as viewed from below. FIG. 10 schematically shows positions of openings 39C and 39D formed on the bottom 39. That is, FIG. 10 schematically illustrates the bottom 39 as viewed from above.

As described above, the legs 33 are provided at the left and right ends of the lower cabinet 3 in the rear projector 1 as shown in FIG. 9. Legs 39A and 39B having a substantially circular shape in the plan view are formed on the rear part of the lower surface of the bottom 39 in which the legs are provided in such positions as to be symmetric with respect to the center in the right-to-left direction of the bottom 39.

A frame-shaped leg 391 which extends approximately downward from the outer edge of the bottom 39 is provided on the bottom 39. The frame-shaped leg 391 produces a predetermined clearance between the bottom 39 and an installation surface such as a stand. The air inlets 36A and 36B (FIG. 2) are provided on the rear surface of the frame-shaped leg 391 to form a layer of air in the space below the bottom 39, i.e., the space between the bottom 39 and the installation surface. Thus, the air outside of the rear projector 1 introduced through the air inlets 36A and 36B flows from the air inlets 36A and 36B to the space below the bottom 39.

The opening 39C which is similarly slit-shaped is formed on the right part of the bottom 39 from the center, while the slit-shaped opening 39D is formed on the left part of the bottom 39 from the center.

The opening 39C is disposed on the bottom 39 below the light source device 41, and has a shape corresponding to that of the light source device 41.

As illustrated in FIG. 10, the opening 39D has a substantially rectangular shape and is disposed below the control board 5 in such a position as to cover the control board 5 and the cooling fan 81 interposed between the control board 5 and the power source block 61. The cooling fan 81 is an axial fan which rotates a fan around its rotation axis to introduce and discharge air along the rotation axis. The cooling fan 81 is disposed in such a position that its air intake plane is opposed to the control board 5 and that its air discharge plane is opposed to the power source block 61.

As illustrated in FIG. 9, ribs 39F for securing strength of the bottom 39 stand from the lower surface of the bottom 39 and extend in the longitudinal and transverse directions. The ribs 39F are not provided in the ranges between the air inlet 36A and the opening 39C and between the air inlet 36B and the opening 39D. Thus, in the condition that the rear projector 1 is placed on the installation surface, the ribs 39F function as duct-like partition walls to guide the air, which is introduced through the air inlets 36A and 36B to the space below the bottom 39, toward the openings 39C and 39D. It is therefore possible to separately form an airflow path along which the air introduced through the air inlet 36A flows into the opening 39C and reaches the light source device 41 and the light source driving block 62, and an airflow path through which the air introduced through the air inlet 36B flows into the opening 39D and reaches the control board 5 and the power source block 61.

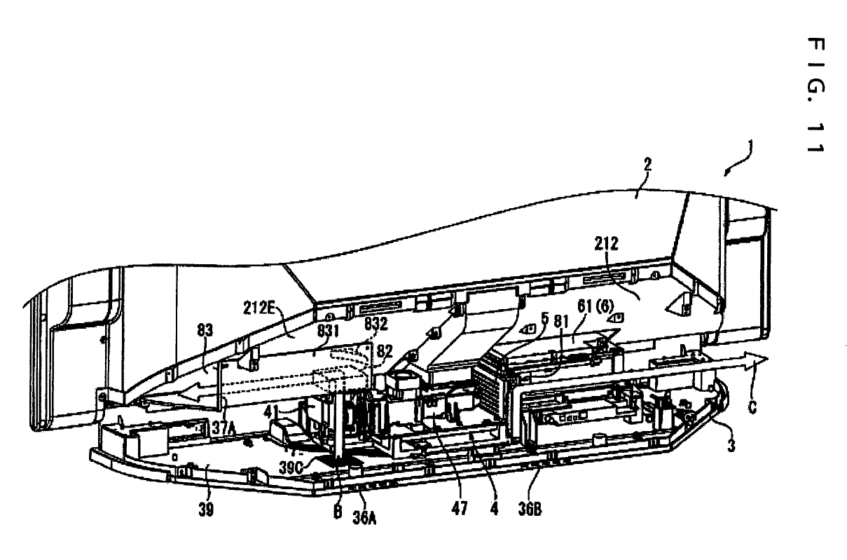

FIG. 11 illustrates cooling airflow paths for cooling the components equipped within the rear projector 1. In FIG. 11, cooling airflow paths B and C are flow paths where air coming from the openings 39C and 39D, respectively, flows within the lower cabinet 3 and are shown by arrows in the figure, but flow paths where air introduced from the air inlets 36A and 36B flows into the openings 39C and 39D are not shown in the figure.

As illustrated in FIG. 11, a cooling fan 82 for cooling the light source device 41 and the light source driving block 62, and a duct 83 for introducing air discharged from the cooling fan 82 to the air outlet 37A are provided above the light source device 41 within the lower cabinet 3.

The cooling fan 82 is a sirocco fan for introducing air from the direction of its fan rotation axis and discharging the air in the direction tangential to the fan rotation. The cooling fan 82 is disposed in such a position that its air intake plane faces to the light source device 41 and that its air discharge plane faces to the air outlet 37A.

The duct 83 is a duct having a substantially triangle cross section which is formed by attaching a plate-shaped member 831 having a substantially L-shaped cross section to a rear surface 212E of the bottom wall 212 of the upper cabinet 2. The duct 83 is disposed in such a position as to cover the cooling fan 82, and has a notch at a position corresponding to the air intake plane of the cooling fan 82 so that air attracted by the cooling fan 82 is not hindered by the duct 83. A partition member 832 for preventing back flow of air from the air outlet 37A is provided within the duct 83 at a position closer to the projection lens 46 away from the cooling fan 82.

6-2. Cooling Airflow Path
The cooling airflow path B for cooling the light source device 41 and the light source driving block 62 and the cooling airflow path C for cooling the control board 5 and the power source block 61 are now described.

The cooling airflow path B is an airflow path where air outside the rear projector 1 introduced from the air inlet 36A flows to cool the light source device 41 and the light source driving block 62 (FIG. 10) and to be discharged through the air outlet 37A to the outside of the rear projector 1. The cooling airflow path B extends in the inside left part of the lower cabinet 3 (left region in FIG. 11) as viewed from the rear.

More specifically, the air outside the rear projector 1 introduced through the air inlet 36A to the space below the bottom 39 flows through the space partitioned by the ribs 39F and reaches the opening 39C as illustrated in FIG. 9. As described above, the opening 39C is positioned just below the light source device 41. Then, the air around the opening 39C is attracted by the cooling fan 82 as illustrated in FIG. 11, and flows upward along the light source device 41 and the light source driving block 62 (FIG. 10) while cooling the light source device 41 and the light source driving block 62 (FIG. 10). Since the air discharge plane of the cooling fan 82 faces to the air outlet 37A, the air having cooled these components and attracted by the cooling fan 82 is discharged from the air discharge plane of the cooling fan 82 into the duct 83, passes through the duct 83, and is then discharged through the air outlet 37A to the outside of the rear projector 1.

Accordingly, in the structure where the cooling airflow path B circulates within the duct 83, the air heated after cooling the light source device 41 and the light source driving block 62 does not stay but diffuses within the lower cabinet 3. Since the air after cooling is thus efficiently discharged, the temperature increase within the lower cabinet 3 can be prevented.

The cooling airflow path C is an airflow path where air outside the rear projector 1 introduced through the air inlet 36B cools the control board S and the power source block 61, and then is discharged to the outside of the rear projector 1 through the air outlets 37B and 37C. The cooling airflow path C extends in the inside right part of the lower cabinet 3 (right region in FIG. 11) as viewed from the rear.

More specifically, as illustrated in FIG. 11, air outside the rear projector 1 introduced through the air inlet 36B to the space below the bottom 39 flows within the space partitioned by the ribs 39F (FIG. 9) to reach the opening 39D (FIG. 9) similarly to the cooling airflow path B. The air coming from the opening 39D flows along the control board 5 by the attraction of the cooling fan 81 disposed between the control board 5 and the power source block 61, and reaches the air intake plane of the cooling fan 81 while cooling the control board 5. Thereafter, the air attracted by the cooling fan 81 is discharged thereby toward the power source block 61. The discharged air flows along the power source block 61 while cooling the power source block 61. A part of the air having cooled the power source block 61 is discharged to the outside of the rear projector 1 through the air outlet 37B, and the remaining part is discharged thereto through the air outlet 37C. More specifically, the air having cooled the control board 5 and the power source block 61 is discharged chiefly through the air outlet 37C provided at a lower position when the temperature of the air is low in such a case as the initial driving of the rear projector 1, and is discharged chiefly through the air outlet 37B provided at an upper position when the inside temperature is increased and thus the air temperature becomes high.

The rear projector 1 in this embodiment offers the following advantages.

The optical unit 4, the control board 5 and the power source unit 6 are accommodated within the lower cabinet 3 along the screen 2B held by the upper cabinet 2. The pair of the light source device 41, and the light source driving block 62 included in the power source unit 6 are disposed on the side opposite to the pair of the control board 5 and the power source system (the power source block 61 included in the power source unit 6) side with the projection lens 46 interposed between the pairs. The pair of the light source device 41 and the light source driving block 62 and the pair of the power source block 61 and the control board 5 are disposed on the bottom 39 of the lower cabinet 3 with a space left between each pair.

In this arrangement, it is possible to prevent heat generated in either the pair of the light source device 41 and the light source driving block 62 or the pair of the power source block 61 and the control board 5 from being conducted to the other pair during operation of the rear projector 1. Accordingly, the rear projector 1 can operate in a stable condition.

The cooling airflow path B for cooling the light source device 41 and the light source driving block 62 and the cooling airflow path C for cooling the control board 5 and the power source block 61 do not intersect each other, and air is discharged through the air outlet 37A provided on one side of the lower cabinet 3 and through the air outlets 37B and 37C provided on the opposite side thereof. In this structure, the heat of air having cooled either pair does not affect the air for cooling the other pair. It is therefore possible to prevent heat interference between the cooling airflow paths B and C, which allows the light source device 41, the light source driving block 62, the control board 5, and the power source block 61 to be further efficiently cooled.

The cooling airflow paths B and C are separately formed in the range from the introduction of air into the inside of the rear projector 1 to the discharge of air to the outside of the rear projector 1. More specifically, the air inlet 36A through which air for cooling the light source device 41 and the light source driving block 62 is introduced and the air inlet 36B through which air for cooling the control board 5 and the power source block 61 is introduced are separately provided in the rear part of the lower cabinet 3. The respective airflows introduced through these air inlets 36A and 36B into the space below the bottom 39 go through the corresponding spaces separated by the ribs 39F and reach the openings 39C and 39D, respectively. The respective airflows at the openings 39C and 39D are attracted by the cooling fans 82 and 81, respectively, so as to be discharged in the directions away from each other. During this process, air flowing along the cooling airflow path B cools the light source device 41 and the light source driving block 62, while air flowing along the cooling airflow path C cools the control board 5 and the power source block 61. Since the cooling airflow paths B and C which are separately formed do not cross each other, the possibility of heat interference between the cooling airflow paths B and C can be further reduced. Accordingly, the efficiency of cooling the light source device 41, the light source driving block 62, the control board 5 and the power source block 61 can be further increased.

The cooling fan 82 for forming the cooling airflow path B is disposed above the light source 41 such that its air intake plane is opposed to the light source device 41. In this arrangement, air around the opening 39C, the light source device 41 and the light source driving block 62 flows along the light source device 41 and the light source driving block 62 while attracted onto the air intake plane of the cooling fan 82 by the operation of the cooling fan 82. If the air discharge plane of the cooling fan 82 is opposed to the light source device 41 and the light source driving block 62, air sent from the air discharge plane of the cooling fan 82 is supplied to the areas of the light source device 41 and the light source driving block 62 opposed to the air discharge plane. However, when the supplied air hits those areas, it diffuses because its wind pressure is reduced. It is, therefore, not always ensured that the air is supplied to other areas of the light source device 41 and the light source driving block 62. On the other hand, in the arrangement where the air intake plane of the cooling fan 82 is opposed to the light source device 41, the pressure of air around the air intake plane is reduced when the cooling fan 82 is actuated. Then, the air whose wind pressure does not greatly vary securely flows along the light source device 41 and the light source driving block 62 without staying thereabout. Accordingly, cooling air can be securely supplied to the light source device 41 and the light source driving block 62, and thus the efficiency of cooling the light source device 41 and the light source driving block 62 can be enhanced.

7. Modification of Embodiment
While the preferred embodiment and other specific structures according to the invention have been described above, the invention is not limited thereto. More specifically, while the specific embodiment of the invention has been chiefly described and shown in the figures in particular, those skilled in the art may give various modifications and changes in shape, material, quantity, and other specific structures to the above embodiment without departing from the scope of the technical spirit and object of the invention.

Therefore, the description for limiting the shapes, materials and the like shown in the above embodiment are only examples for making the invention easily understood and does not limit the invention at all. In this context, description showing component names partially or entirely out of limitations in the shapes, materials and the like will be similarly included in the scope of the invention.

In the above embodiment, the air discharged from the cooling fan 82 after cooling the light source device 41 and the light source driving block 62 flows within the duct 83. However, the duct 83 is not necessarily needed, and the cooling air may be discharged from the air discharge plane of the cooling fan 82 directly through the air outlet 37A to the outside when the distance between the air discharge plane of the cooling fan 82 and the air outlet 37A is short. When the distance between the air discharge plane of the cooling fan 82 and the air outlet 37A is long, the air discharged from the air discharge plane of the cooling fan 82 preferably flows within the duct 83 so as to prevent diffusion of the heated cooling air within the lower cabinet 3 and also enhance the discharge efficiency.

In the above embodiment, the cooling fan 82 for cooling the light source device 41 and the light source driving block 62 is a sirocco fan which is disposed above the light source device 41 in such a position that the air intake plane of the cooling fan 82 is opposed to the light source device 41. However, the cooling fan 82 may be an axial fan and is disposed below the light source device 41 in such a position that the air discharge plane of the cooling fan 82 is opposed to the light source device 41. If the cooling fan 82 is positioned such that its air intake plane is opposed to the light source device 41, air for cooling the light source device 41 and the light source driving block 62 flows while attracted toward those. Accordingly, the efficiency of cooling the light source device 41 and the light source driving block 62 can be further increased.

In the above embodiment, the air inlets 36A and 36B are formed on the rear surface of the lower cabinet 3, and air introduced through the air inlets 36A and 36B into the lower cabinet 3 flows within the space below the bottom 39. However, the air inlets 36A and 36B are not necessarily required to be provided on the rear surface of the lower cabinet 3, but may be formed on either surface of the lower cabinet 3 as long as air can be introduced into the lower cabinet 3 when the rear projector 1 is installed. Alternatively, air introduced through the air inlets 36A and 36B may be guided directly toward the area above the bottom 39. In the structure where the introduced air flows within the space below the bottom 39, the cooling airflow path B for cooling the light source device 41 and the light source driving block 62 and the cooling airflow path C for cooling the control board 5 and the power source block 61 can be more securely separated. It is therefore possible to prevent heat interference between these paths and thus enhance their cooling efficiency.

In the above embodiment, the ribs 39F for separating air introduced through the air inlets 36A and 36B are formed on the lower surface of the bottom 39. However, the ribs 39F are not necessarily needed. If the ribs 39F are formed on the lower surface of the bottom 39 and a duct-shaped partition wall for guiding air introduced through the air inlet 36A to the opening 39C and a duct-shaped partition wall for guiding air introduced through the air inlet 36B to the opening 39D are equipped by the ribs 39F, it is possible to more securely separate the cooling airflow paths B and C from each other and also increase the strength of the bottom 39.

In the above embodiment, the bottom 39 of the lower cabinet 3 is disposed a predetermined distance away from the installation surface on which the lower cabinet 3 is placed. However, the bottom 39 may be formed by a pair of plate-shaped members vertically opposed to each other with a predetermined clearance provided therebetween. In this case, the light source device 41 and other components are mounted on the upper plate-shaped member, and the lower plate-shaped member contacts the installation surface, for example. Cooling air may flow through the clearance between the pair of the plate-shaped members. In this structure, the capacity of the space below the bottom 39 is not decreased when the rear projector 1 is installed on a carpet or the like. It is therefore possible to secure a sufficient flow amount of cooling air flowing within the space below the bottom 39 and prevent dust and the like from directly entering through the openings 39C and 39D into the lower cabinet 3.

In the above embodiment, the pair of the light source device 41 and the light source driving block 62 is disposed opposite to the pair of the control board 5 and the power source block 61 side with the projection lens 46 of the optical unit 4 interposed between the pairs. A partition wall for separating the spaces where the respective pairs are disposed may be equipped within the lower cabinet 3. In this case, the possibility of attracting the air around the opening 39C by the cooling fan 81 and the possibility of attracting the air around the opening 39D by the cooling fan 82 can be eliminated. It is therefore possible to completely separate the cooling airflow paths B and C and thus further enhance the efficiency of cooling the light source device 41, the light source driving block 62, the control board 5, and the power source block 61 by preventing heat interference between the cooling airflow paths B and C.

In the above embodiment, the light source driving block 62 is disposed close to the light source device 41. However, the light source driving block 62 may be positioned away from the light source device 41. Additionally, while the light source driving block 62 and the light source device 41 are cooled by the air flowing along the cooling airflow path B in the above embodiment, the light source driving block 62 may be arranged otherwise. That is, the light source driving block 62 is not required to be disposed above the cooling airflow path B as an airflow path for cooling the light source device 41.

Since the light source driving block 62 is disposed away from the power source block 61, it is possible to prevent noise generated from the power source block 61 from adversely affecting the light source driving block 62. Additionally, when the light source driving block 62 is disposed close to the light source device 41, it is possible to simplify the wiring arrangement and also cool the light source driving block 62 using the air supplied to the light source device 41. Accordingly, the structure where the light source driving block 62 is disposed close to the light source device 41 allows stable operation of the rear projector 1 and also increases the efficiency of cooling the light source driving block 62 and the light source device 41.

While the rear projector using three light modulation devices is employed in the above embodiment, a rear projector including a single light modulation device, two light modulation devices, or four or more light modulation devices may be employed. Also, while the liquid crystal panels are used as the light modulation devices in the embodiment, light modulation devices including micro-mirrors other than liquid crystals may be employed. Furthermore, reflection-type light modulation devices may be employed in lieu of the transmissive-type light modulation devices.

While the optical unit 4 is substantially L-shaped in the plan view in the above embodiment, the optical unit 4 may have other shapes such as a substantially U shape in the plan view.

As aforementioned, some aspects of the invention are appropriately applied to a rear projector.

What is claimed is:

1. A rear projector, comprising:
a light source device;
an optical system including a light modulation device that modulates light emitted from the light source device based on image information to produce an image, and a projection optical device that enlarges and projects the image produced by the light modulation device;
a screen on which a projection image coming from the projection optical device is projected;
a power source system that supplies driving power to the entire rear projector;
a housing that accommodates the light source device, the optical system, the power source system, and the screen;
the housing having a pair of sides which are opposed to each other and extend from ends of a housing surface on which the screen is formed toward the rear surface of the housing;
the light source device being disposed on a side opposite to the power source system side with the optical system interposed therebetween, and the light source device, the optical system and the power source system being arranged along the projection surface of the screen; and
a first air outlet through which air that cools the light source device is discharged being formed on a side of the housing adjacent to the light source device, and a second air outlet through which air that cools the power source system is discharged being formed on a side of the housing adjacent to the power source system.

2. A rear projector according to claim 1, further comprising:
a duct that connects the first air outlet and the light source device, and that guides the air that cools the light source device through the first air outlet to the outside.

3. A rear projector according to claim 1, further comprising:
a cooling fan that cools the light source device and that is provided between the first air outlet and the light source device; and
the air intake plane of the cooling fan being opposed to the light source device.

4. A rear projector according to claim 1,
the housing having legs and a bottom on which at least the light source device and the power source system are arranged within the housing;
the bottom of the housing being disposed a predetermined distance away from an installation surface on which the housing is installed;
at least two air inlets, through which air is introduced into a space below the bottom of the housing when the housing is installed, being formed at least on any surface of the housing; and
a light source device cooling opening through which air entering from one of the two air inlets is introduced to the light source device being formed adjacent to the light source device, and a power source system cooling opening through which air entering from the other air inlet is introduced to the power source system being formed adjacent to the power source system.

5. A rear projector according to claim 4, a partition wall that separates air introduced through the air inlets being disposed on a lower surface of the bottom of the housing.
